(19) United States
(12) Patent Application Publication
(10) Pub. No.: US 2024/0341930 A1
(43) Pub. Date: Oct. 17, 2024

(54) ANATOMY DRIVEN COMPUTER-AIDED DESIGN AND MANUFACTURE OF DENTAL RESTORATIONS FOR TREATMENT OF DENTAL PATHOLOGIES

(71) Applicant: INSTITUT STRAUMANN AG, Basel (CH)

(72) Inventors: Andreas KUNERT, Graefelfing (DE); Sergej HARSCH, Graefelfing (DE); Sylvain CRESSON, Lyon (FR); Stephane BUY, Lyon (FR); Fleur KASPER, Berlin (DE); Uwe LAWITSCHKA, Berlin (DE); Marlon SHARPE, Berlin (DE); Mathieu GUINDON, Montreal (CA)

(21) Appl. No.: 18/669,598

(22) Filed: May 21, 2024

Related U.S. Application Data
(63) Continuation of application No. PCT/IB2021/061083, filed on Nov. 29, 2021.

(51) Int. Cl. A61C 13/00; A61C 5/77; G06F 30/10; G06T 19/20

(52) U.S. Cl. CPC A61C 13/0004; A61C 5/77; G06F 30/10; G06T 19/20

(57) ABSTRACT

A method for creating a digital dental restoration model. The method includes receiving a three-dimensional virtual model of oral structures of a patient, receiving classification data classifying an oral situation of the patient, and determining a three-dimensional (3D) geometry that defines a surface anatomy of the digital dental restoration. The method further includes automatically filtering, based on the determined 3D geometry, a set of possible first restoration design variables by restricting respective first restoration design variables to be compatible with the determined 3D geometry, and receiving an input that identifies a selected first restoration design variable from the filtered set of first restoration design variables.

### CROSS REFERENCE TO RELATED APPLICATIONS

This application is a continuation of International Application No. PCT/IB2021/061083 (WO 2021/094866 A1), filed on Nov. 29, 2021. The aforementioned application is hereby incorporated by reference herein.

### FIELD

The present disclosure relates to prosthodontics and prosthetic dentistry and, in particular, to a method, system, and computer-readable medium for the design and manufacture of dental restorations. Dental restorations can be designed using computer aided design (CAD) software and manufactured so as to be insertable into a patient's oral cavity for treatment of dental pathologies.

### BACKGROUND

Currently available computer aided design (CAD) software for dental restoration design requires, as a set of initial inputs, selection of specific prosthetic components, materials to be used in the manufacture of certain prosthetic components, and processes to be used for manufacturing the prosthetic components. As a result, definitive restoration properties must be defined at the very beginning of the case creation and without the benefit of information developed during the design of the functional and aesthetic components of the restoration.

### SUMMARY

According to an embodiment, the present disclosure provides a method for creating a digital dental restoration model. The method includes receiving a three-dimensional virtual model of oral structures of a patient, receiving classification data classifying an oral situation of the patient, and determining a three-dimensional (3D) geometry that defines a surface anatomy of the digital dental restoration. The method further includes automatically filtering, based on the determined 3D geometry, a set of possible first restoration design variables by restricting respective first restoration design variables to be compatible with the determined 3D geometry, and receiving an input that identifies a selected first restoration design variable from the filtered set of first restoration design variables.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an intraoral scanner designed to acquire scan data for constructing a 3D digital model of dentition and oral tissues of a patient;

FIG. 2 illustrates an intraoral scanner hardware platform including the intraoral scanner of FIG. 1;

FIG. 3 illustrates an alternative intraoral scanner hardware platform including the intraoral scanner of FIG. 1;

FIG. 4 illustrates an exemplary method of constructing a prosthodontic model within the case creation environment (CCE) for a tooth-borne full anatomy crown;

FIG. 5 illustrates an exemplary method of constructing a prosthodontic model within the CCE for a tooth-borne reduced anatomy bridge;

FIG. 6 illustrates an exemplary method of constructing a prosthodontic model within the CCE for an implant-borne bridge with an angled screw channel and a full anatomy bridge;

FIG. 7 illustrates an exemplary method of constructing a prosthodontic model within the CCE for an implant-borne bridge with an angled screw channel;

FIG. 8 illustrates an exemplary embodiment of a user interface (UI) of the CCE presenting an anatomy as an independent manipulable data structure, with multiple sets of feature selections available to the user simultaneously;

FIG. 9 illustrates an exemplary embodiment of the UI of the CCE presenting feature selections for a creation of a treatment plan;

FIG. 10 is a block diagram of an exemplary processing system, which can be configured to perform operations described herein; and

FIG. 11 is a block diagram of a system configured to perform operations described herein.

### DETAILED DESCRIPTION

Selection of specific components, materials, and manufacturing processes for tooth-borne, implant-borne, and edentulous dental restorations—without fully analyzing or considering certain oral conditions that flow from the design of the functional and aesthetic features of such restorations—can lead to a number of problems. Because the functional and aesthetic features of such restorations determine interproximal and occlusal spacing, impact gingiva conditions, and affect other aspects of the oral situation, selection of specific components, materials, and manufacturing processes prior to the design of the restorations functional and aesthetic features can lead to mis-selections, i.e. of restoration types and prosthetic components, materials, and manufacturing processes.

As a result of such mis-selections, certain portions of the design process may need to be repeated—possibly multiple times—in order to produce a viable dental restoration that both conforms with the patient's existing oral situation and properly addresses a patient's dental pathologies. In some instances, such mis-selections can force a restart of the design process from the very beginning. As a result, the design process can become very time consuming and increase the cost of producing such restorations. Furthermore, selection of specific components, materials, and manufacturing processes prior to the determination of the functional and aesthetic features of such restorations can foreclose the selection of certain options that would both be compatible with the functional and aesthetic features of the restoration and provide for a superior restoration overall—e.g. by enhancing integration of the component parts of a dental restoration to improve reliability and service life. Furthermore, selection of restoration design parameters prior to designing the functional and aesthetic features of the restoration leads to the functional and aesthetic features being selected to conform with the previously selected design parameters. However, because aesthetics and masticatory functionality are the most important design considerations for dental prosthetic restorations, they should be prioritized in any design process. Designing the functional and aesthetic features of the restoration first and subsequently selecting other features/properties of the restoration would facilitate the design of superior restorations and lead to improved patient outcomes.

Aspects of the present disclosure provide methods, systems, and computer-readable media that provide for the design and manufacture of dental restorations. According to aspects of the present disclosure, the dental restorations can be designed using computer aided design (CAD) software and subsequently manufactured so as to be insertable into a patient's oral cavity for treatment of dental pathologies. Aspects of the present disclosure address the aforementioned problems (associated with selection of restoration features prior to the definition of the functional and aesthetic features of the restoration) by defining the patient case and its properties gradually during the design and manufacturing workflow. In particular, the patient case and its properties are defined subsequently to and based on a definition of the aesthetic and functional features of the restoration—e.g. based on a three-dimensional (3D) geometry that defines an exterior surface of one or more crown portions of the restoration. Following the design of such a three-dimensional geometry—which can be provided as a data structure, e.g. in the form of a three-dimensional triangle mesh—the methods, systems, and computer-readable media of the present disclosure utilize the 3D geometry to determine additional features of the patient case.

Gradually defining the patient case and its properties ensures that the design process can proceed from start to finish without costly mis-selections leading to duplication of design steps and associated wasted time and effort. In this manner, aspects of the present disclosure can avoid wasted time and effort in the prosthetic design and manufacture process. Furthermore, gradually defining the patient case and its properties ensures that decisions concerning the selection of prosthetic component parameters, materials, and manufacturing processes can be made with the benefit of information concerning the functional and aesthetic features of the restoration. By using information concerning the functional and aesthetic features of the prosthetic, e.g. a geometry that defines an exterior surface of one or more crown portions of the restoration, to inform various prosthetic design choices, the design process can facilitate better patient outcomes by improving the compatibility of such prosthetic design choices with the functional and aesthetic features. In this manner, aspects of the present disclosure facilitate the design of prosthetic restorations that exhibit improved reliability through enhanced compatibility between their component parts. Furthermore, by ensuring that prosthetic design choices (e.g. of internal, structural components, materials, and manufacturing processes) are based on the functional and aesthetic features of the restoration—as opposed to basing the functional and aesthetic features of the restoration on initial, relatively uninformed design choices—aspects of the present disclosure facilitate the design of prosthetic restorations that exhibit improved aesthetics, masticatory functionality, and compatibility with patients' oral situations.

The construction of a prosthodontic restoration requires the specification of many different design variables (DV) that specify properties and/or represent structural components of the restoration. Furthermore, the selection of one DV is, in many cases, dependent on the selection of other DVs. Aspects of the present invention reduce the complexity and error rate of prosthodontic restoration design and creation by splitting up the case creation, and by relocating and pre-filtering selections of mandatory restoration properties within the case creation process. As a result, prosthodontic professionals, e.g. prosthodontists and prosthodontic laboratory engineers, can better analyze oral conditions before deciding on a definitive restoration type, manufacturing process, and material. This avoids wasted time and effort on the part of prosthodontic professionals, e.g. attributable to from needing to change the restoration type, material, or manufacturing process due to selection of DVs that are incompatible in combination with one another and with an oral situation of a patient.

To improve the design process, and the experience of prosthodontic professionals, even further, all mandatory and related selections can be driven by a top-to-bottom filter approach. In using such an approach, a user interface can be provided that gradually guides the professional through the different selections and only provides the professional with selections that are compatible with, e.g., a data structure that represents a 3D geometry of an exterior surface of one or more crown portions of the restoration. With this approach, aspects of the present disclosure are capable of providing only valid combinations of prosthetic DVs for the user to select from, which eliminates wasted time and resources associated with repeating the case creation process, or a subset thereof, each time an invalid combination is made. Aspects of the present disclosure thus help prevent prosthodontic professionals from selecting incompatible or invalid combinations of prosthodontic DVs and reduce UI complexity. Aspects of the present disclosure therefore improve user experience, reduce the number of user errors, and increase the number of prosthodontic restorations that can be generated by a prosthodontic professional within a given time frame.

Aspects of the present disclosure additionally ensure that the anatomy of the dental restoration, e.g. a 3D geometry that defines an exterior surface of one or more crown portions of the dental restoration, which primarily determines the masticatory functionality of the restoration and which has a significant impact on its aesthetics, will be defined early in the design workflow. Defining the anatomy of the dental restoration at an early stage of the design process ensures that subsequent selections of DVs can be made with the benefit of the final, or very nearly final, anatomy of the dental restoration. Defining the anatomy at an early stage of the design process additionally aids the user to analyze the oral environment that will result when the restoration is inserted into the patient's oral cavity. Moreover, defining the anatomy at an early stage allows for DVs related to the restoration's inner features, e.g., core and shell components and thicknesses of various materials that make up the core and shell components, to be selected based on their compatibility with the defined anatomy. This represents a significant benefit over state-of-the-art CAD solutions-which involve defining, in part, the anatomy of the prosthetic as the crown's inner features are recomputed.

Embodiments of the present disclosure enable users to make dental restoration specific decisions after certain oral conditions e.g., interproximal and occlusal spacing, residual teeth, and gingiva conditions, have been analyzed. Case creation is therefore split up to define the patient case specific requirements incrementally during the design workflow. In other words, prosthodontic professionals create the patient case gradually as more knowledge of the oral situation and its specific restrictions is acquired. For example, selection of materials, e.g. for forming one or more crown portions of the restoration, can be performed at a later stage of the design process as compared with state-of-the-art CAD solutions. Materials often represent a limitation on geometries that can be chosen; while in the prior art materials are usually selected early on, the present invention can avoid the waste of an iterative process of going back to the selection of material components step when the geometry constraints are not compatible with the selected material.

According to an aspect of the present disclosure, a method is provided for creating a digital dental restoration. The method includes receiving a three-dimensional (3D) virtual model of oral structures of a patient, receiving classification data classifying an oral situation of the patient, and determining a 3D geometry that defines a surface anatomy of the digital dental restoration. The method further includes automatically filtering, based on the determined 3D geometry, a set of possible first restoration design variables by restricting respective first restoration design variables to be compatible with the determined 3D geometry. In addition, the method includes receiving an input that identifies a selected first restoration design variable from the filtered set of first restoration design variables.

The 3D geometry that defines the surface anatomy of the digital dental restoration can be a 3D geometry that defines an exterior surface of one or more crown portions of the restoration, or that defines an exterior surface of a part of one or more crown portions. Determining the 3D geometry that defines the surface anatomy of the digital dental restoration can further include creating a data structure that defines the exterior surface of one or more crowns, or portions of one or more crowns, that are to be replaced by the restoration. The data structure can be a polygon mesh, e.g. a triangle mesh.

In the method according to the first aspect of the present disclosure, the classification data can provide a respective condition of each of one or more teeth that are to be replaced by the dental restoration. The classification data can also provide a respective condition of each of the teeth of a patient or each of the teeth of the patient that are represented in the 3D virtual model of the oral structures of the patient. The classification data can be, for example, indexed according to tooth number, e.g. as specified according to the FDI World Dental Federation notation (FDI notation). For example, the classification data can include, for each tooth specified by the FDI notation, a respective condition selected from a set of tooth conditions. The set of tooth conditions can include individual conditions that indicate that the respective tooth is a preparation tooth, that an implant replaces the respective tooth, that the respective tooth has been extracted and is not replaced by an implant. For example, the classification data for tooth numbers 7-9 could specify “implant-gingiva-implant.”

The method according to the first aspect of the present disclosure can further include, after determining the 3D geometry that defines the surface anatomy of the digital dental restoration, determining, for each respective tooth of the one or more teeth of the patient that are to be replaced by the dental restoration, a respective restoration type. In this manner, the method can specify the respective restoration type after the surface anatomy of the digital dental restoration has already been determined. The restoration type can include, for each respective tooth that is to be replaced by the dental restoration—as indexed according to FDI notation, for example—a restoration type. Each respective restoration type can be selected from a set of restoration types, the set of restoration types including one or more of: implant-supported crown, preparation tooth-supported crown, pontic, implant-supported partial crown, preparation tooth-supported partial crown, inlay, onlay, overlay, veneer. For example, the restoration type for tooth numbers 7-9 could be specified as “implant-supported crown, pontic, implant-supported crown.” Determining the respective restoration type can be accomplished by receiving, for each respective tooth of the one or more teeth of the patient that are to be replaced by the dental restoration, user input indicating the respective restoration type. Alternatively, determining the respective restoration type can be accomplished by automatically identifying the restoration type for each tooth, e.g. based on the determined 3D geometry and the classification data of the corresponding tooth or teeth, and the automatically identified restoration type can be verified by a user.

In the method according to the first aspect of the present disclosure, the set of possible first restoration design variables can include, for each respective tooth of the one or more teeth of the patient that are to be replaced by the dental restoration, one or more of: a margin line, an emergence profile, a cement gap, a final restoration minimum thickness, e.g. a crown material minimum thickness. Restricting respective first restoration design variables that are incompatible with the determined 3D geometry can includes specifying one or more of: valid margin line parameter ranges, valid emergence profile parameter ranges, valid cement gap parameter ranges, valid crown material thickness ranges, valid shell material thickness ranges. Receiving an input that identifies a selected first restoration design variable from the filtered set of first restoration design variables can include receiving one or more of: valid margin line parameters, valid emergence profile parameters, valid cement gap parameters, valid crown material thicknesses, valid shell material thicknesses. The set of possible first restoration design variables can also include one or more of: an implant-mounted abutment, an implant-mounted bar, and a bar-mounted restoration. Restricting respective first restoration design variables that are incompatible with the determined 3D geometry can then include specifying one or more of: valid parameters for an implant-mounted abutment, valid parameters for an implant-mounted bar, valid parameters for a bar-mounted restoration. Receiving an input that identifies a selected first restoration design variable from the filtered set of first restoration design variables can then include one or more of: valid parameters for an implant-mounted abutment, valid parameters for an implant-mounted bar, valid parameters for a bar-mounted restoration.

The method according to the first aspect of the present disclosure can additionally include automatically filtering, based on the determined 3D geometry and the selected first restoration design variable, a set of possible second restoration design variables by restricting second restoration design variables to be compatible with a combination of the determined 3D geometry and the selected first restoration design variable. The set of possible second restoration design variables can include a set of possible materials and material colors for use in manufacture of a dental restoration corresponding to the digital dental restoration. Restricting second restoration design variables to be compatible with a combination of the determined 3D geometry and the selected first restoration design variable can include eliminating, from a set of materials and corresponding material colors provided for the manufacture of dental restorations, those materials and corresponding material colors that are not compatible with the determined 3D geometry and the selected first restoration design variable.

According to another aspect of the present disclosure, a system for creating a digital dental restoration is provided. The system includes processing circuitry, a display configured to provide a user interface and to display a visual rendering of the digital dental restoration, and a user input device configured to receive user input for communication to the processing circuitry. The processing circuitry is configured to receive a three-dimensional (3D) virtual model of oral structures of a patient, receive classification data classifying an oral situation of the patient, determine a 3D geometry that defines a surface anatomy of the digital dental restoration, automatically filter, based on the determined 3D geometry, a set of possible first restoration design variables by restricting respective first restoration design variables to be compatible with the determined 3D geometry, and receive an input, provided via the user input device, that identifies a selected first restoration feature from the set of first restoration features. Various embodiments of the system, and the processing circuitry thereof, can have the same features as the method according to the disclosure or any embodiment thereof.

According to another aspect of the present disclosure, a non-transitory computer-readable medium having instructions stored thereon that, upon being executed by processing circuitry, cause the processing circuitry to carry out the method according to the disclosure or any embodiment thereof.

According to a further aspect of the present disclosure, a method for manufacturing a dental restoration is provided. The method for manufacturing the dental restoration includes the method for creating a digital dental restoration according to the aspect described above and its various embodiments. The method for manufacturing the dental restoration can further include providing the digital dental restoration to a manufacturing apparatus and determining, based on the digital dental restoration, a control routine for controlling the manufacturing apparatus so as to manufacture the dental restoration. The manufacturing apparatus can be, e.g., a milling machine or an additive manufacturing machine.

Embodiments of the present disclosure can relate to the design of a dental restoration configured to be mounted on one or more preparation teeth in a patient's oral cavity as well as to a dental restoration configured to be mounted on one or more implants installed in a patient's oral cavity. At an initial stage of the design process, a user, e.g. a prosthodontic professional, defines an oral situation, e.g. a pathology, of a patient. Embodiments of the present disclosure can provide a UI in a CCE, the UI providing a UI component configured to receive input related to the definition, or classification, of the patient's oral situation. For example, if a tooth has been prepared, the user could select “preparation” from a drop-down menu of options for classifying the oral situation of a particular tooth in the patient's oral cavity, e.g. as classified by tooth number. If two teeth have been prepared and a tooth has been extracted, the user could select preparation, gingiva, and preparation for the oral situation corresponding to each of the three teeth. Such a selection of the oral situation is in contrast to a selection of the restoration type, e.g. bridge (crown-pontic-crown), for the same situation. In embodiments of the present disclosure, the initial stage of case creation requires only that users define the oral situation, instead of completely defining the type of final restoration and properties thereof.

Images of the patient's oral situation can be rendered, within the CCE, based on a 3D model of the patient's oral situation. For example, the CCE can import a 3D model of the patient's oral situation that was provided by an intraoral scan of the patient's dentition. Alternatively, the CCE can import a 3D model provided by a laboratory scan of a positive plaster cast. Typically, a 3D model of the patient's oral situation is constructed from data generated by scanning the upper jaw, the lower jaw, and certain portions of the upper and lower jaws in a bite configuration and then assembling and aligning all the data from each of the scans in a 3D coordinate system. The 3D model of the patient's oral situation is data structure, typically provided in the form of a 3D mesh that represents the 3D geometric structure of the patient's oral structure, e.g. dentition and gingiva. The 3D model can additional include texture, e.g. color, associated with the 3D mesh.

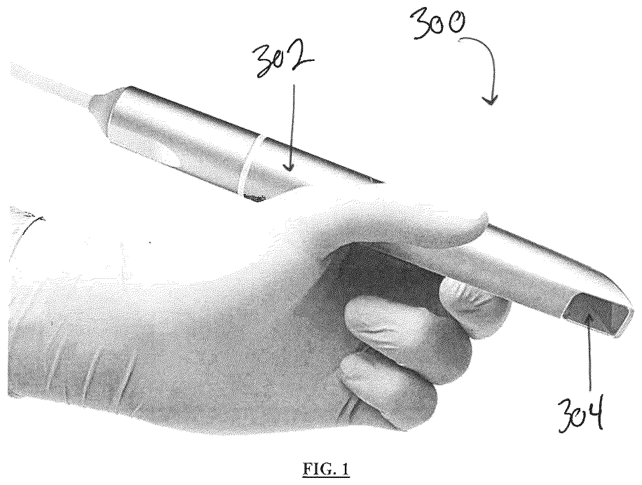

FIG. 1 illustrates an intraoral scanner 300 designed to acquire scan data for constructing a 3D model of the dentition and oral tissues, e.g. gingiva, of a patient. The intraoral scanner includes a handpiece 302 in which multiple cameras 304 and an illuminating light source are disposed. The cameras 304 can include, e.g., a camera configured to acquire images in which ultraviolet light is projected and red, green, and blue monochrome cameras (configured to capture red, green, and blue monochrome images). The illuminating light source can be configured to project ultraviolet pattern light as well as white or red, green, and blue (RGB) light. The UV light and the white/RGB light can be provided from different light sources. The intraoral scanner 300 additionally includes a number of different sensors that are configured to capture data, as well as processing circuitry configured to associate data captured by the sensors with images captured by the cameras 304, e.g. by associating both the data and the images with a timestamp. The sensors include position, orientation, and speed sensors, which can themselves include one or more accelerometers and/or one or more gyroscopes.

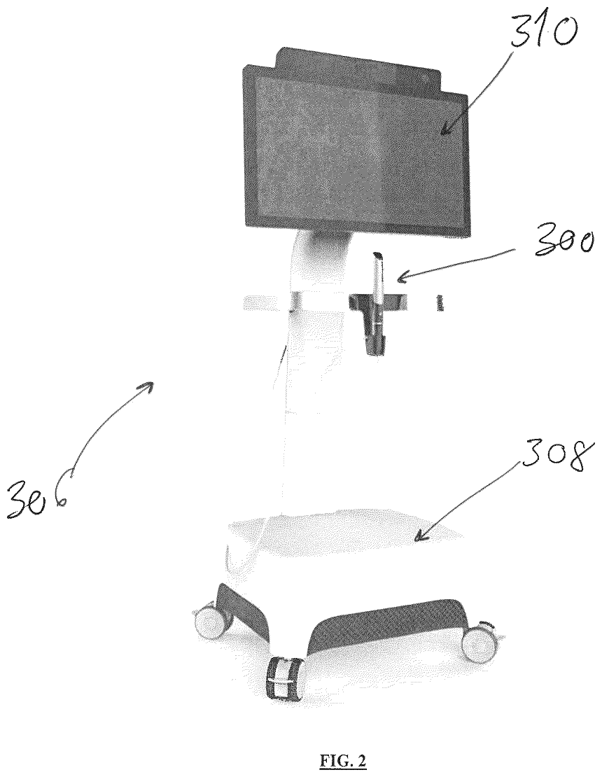

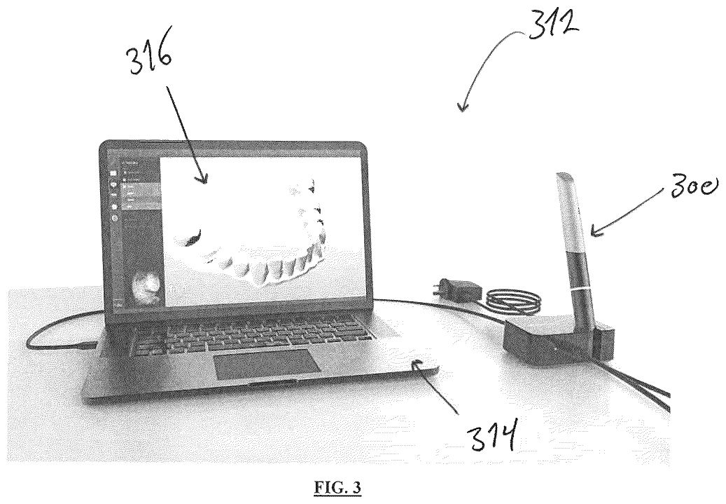

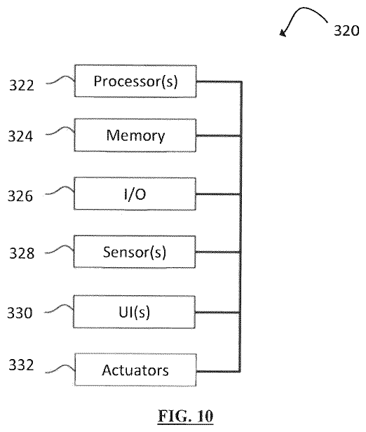

FIG. 2 illustrates an intraoral scanner hardware platform 306 including the intraoral scanner 300 of FIG. 1. The hardware platform 306 of FIG. 2 additionally includes a cart 308 and a display 310 mounted on the cart 308. The hardware platform 306 of FIG. 2 can also include additional processing circuitry configured to process data acquired by the intraoral scanner 300 of FIG. 1 and to perform methods for designing a prosthodontic restoration, e.g. a processing system such as that described in FIG. 10. The display 300 mounted on the cart is configured to display the CCE and its associated UIs to a user, e.g. a prosthodontics professional. FIG. 3 illustrates an alternative intraoral scanner hardware platform 312 including the intraoral scanner 300 of FIG. 1. The alternative hardware platform 312 of FIG. 3 includes a laptop computer 314 to which the intraoral scanner 300 is connected. The laptop computer 314 can include additional processing circuitry configured to process data acquired by the intraoral scanner 300 of FIG. 1 and to perform methods for designing a prosthodontic restoration, e.g. a processing system such as that described in FIG. 10. The laptop computer 314 additionally includes a display 316 configured to display the CCE and its associated UIs to a user, e.g. a prosthodontics professional. As an alternative to or in addition to including additional processing circuitry configured to process data acquired by the intraoral scanner 300 and to perform methods for designing a prosthodontic restoration, both the hardware platform 306 of FIG. 2 and the alternative hardware platform 312 of FIG. 3 can be connected, via a data connection, to such additional processing circuitry, e.g. located in the cloud.

Prior to rendering the patient's oral situation from the 3D model within the CCE, the 3D model can be oriented and tagged. The files of the imported 3D model can be assessed to verify that the 3D model is properly oriented and located within the dimensions and coordinates of the CCE. The imported model can then be trimmed to focus on the relevant portions of the model. If the coordinates of the file system that relays the scan do not result in a properly oriented and located model within the CCE, a coordinate transformation can be performed to orient the coordinates of the imported model with those of the CCE. This orientation step is advantageous because the 3D model may be generated in a first coordinate system different than that used by the CCE. The orientation step provided by the present disclosure therefore provides for compatibility with a wide range of 3D models and the systems with which they are constructed by performing coordinate transformations as necessary to render models imported with different coordinate systems compatible with the coordinates of the CCE.

Once the 3D model is imported into the CCE, it can then be tagged, for example by numbering the teeth within the model or segmenting and partitioning portions of the jaw that correspond to individual or groups of teeth, or some other feature of the model. Tagging can be performed automatically by the CCE or manually by the user. Alternatively, the 3D model can already be tagged prior to being received by the CCE (e.g. include tags in metadata associated with the 3D model), and the tags can be verified automatically by the CCE or manually by the user.

In alternative embodiments, the 3D model can be imported into the CCE and rendered prior to definition of the patient's oral situation, or the patient's oral situation can be defined in the CCE prior to importation and rendering of the 3D model.

After the 3D model preparations, users can select an anatomy library. Anatomy libraries contain sets of generic anatomies that are more or less applicable depending on the parameters input to the CCE. The anatomy libraries can be organized based on a number of parameters. For example, different anatomy libraries may be available based on the age or gender of the patient. Once an applicable anatomy library is chosen, a specific tooth shape/form can be chosen from within the anatomy library. The selected tooth shape/form can then be projected approximately on a predefined location of a preparation tooth or an implant. Users can select from various tooth shapes from within the anatomy library and the selection will be reflected on the 3D model's preparation area inside the 3D view. This provides many advantages. For example, projecting the anatomy approximately onto the preparation's location helps users check if the selection tooth shape is suitable regarding the residual teeth. Additionally, users can see if the selected anatomy library matches the shape and age of the residual teeth in real time instead of selecting from a list of anatomies without knowing if they fit. Possible embodiments of the anatomy library of the present disclosure could be augmented with artificial intelligence such that anatomy templates are suggested or generated by an artificial intelligence module based on the patients oral situation or model generated from the scan file.

After selecting an anatomy library, an anatomy, e.g. a 3D geometry that defines an exterior surface of one or more crown portions of the dental restoration, can be defined for the restoration. The generic tooth shape and form of the anatomy chosen from the anatomy library can be crafted into a final 3D geometry. The anatomy selected from the anatomy library can be placed, scaled, deformed, copied (e.g. replaced by a copy of a residual tooth or another anatomy library tooth), or cloned. This anatomy can, at this stage, be designed and selected on the basis of both functional and aesthetic choices. The user can freely place the anatomy within three dimensional space, without restriction on margin line, path of insertion, cement gap, and material minimum thickness as they have not yet been defined. For example, the user can grab, manipulate, rotate, scale, etc. the external 3D embodiment of the anatomy within the three dimensional space of the CCE. This provides the first indication of which restoration type can be chosen and how the final restoration can be designed depending on the surrounding areas of the locus (opposing arch, residual teeth and gingiva conditions). The resulting anatomy shape and its position can be preserved throughout the whole workflow, even after changes to the bottom part, e.g., inner portion of the anatomy, or changes to the restoration type because the anatomy does not need to be recomputed or recreated.

Embodiments of the present disclosure can construct the anatomy as an independent, standalone data structure that can be rendered, along with the oral situation of the patient, within the CCE. The anatomy data structure can be, e.g., a 3D polygon mesh such as a 3D triangle mesh.

After the surrounding areas of the locus have been analyzed and the anatomy has been placed to fit into the arch, users can decide on the final restoration type, its properties, and the related manufacturing process, e.g., in-house or centralized. In embodiments, the design variable (DV) selection process is driven by a top-to-bottom filter approach. A top-to-bottom approach typically starts with the external DVs of the tooth being decided first and in an order based on their dependency on other variables. Embodiments of a top portion deploy a design workflow with a following structure: the 1st DV selection narrows down the possible selections for the 2nd DV; the 2nd DV selection narrows down the possible selections for the 3rd DV; the 3rd DV selection narrows down the possible selections for the 4th DV; the 4th DV selection narrows down the possible selections for the 5th DV, and controls if the 5th DV is available at all. Exemplary contents of each DV selection can include a 1^{st} DV selection of single crown or a bridge; a 2^{nd} DV selection of restoration type, e.g., full crown, reduced crown, coping, pontic, crown—for each of one or more of a patient's teeth; a 3^{rd} DV selection of production output, e.g., in-house or centralized production; a 4^{th} DV selection of the type of material used to form the anatomy, e.g., ceramic, zirconium; and a 5^{th} DV of the material color. At each stage of the workflow, the possible selections for the DV can be limited by the anatomy of the restoration, i.e. possible DVs can be filtered based on compatibility/incompatibility with the 3D geometry that defines an exterior surface of the one or more crown portions of the dental restoration.

For example, a first DV selection can be selecting between a single tooth restoration or bridge restoration of one or more teeth joined to adjacent teeth. Single or bridge are the possible first DV selections from the first set of DVs. The choice of single or bridge will influence the DV selections available to at the immediately successive set of DVs, the second DV selection. The second DV selection can include selection of the restoration type, and the set of all DVs within the second DV selection can include a full crown, a reduced crown, a coping, a pontic crown, etc. However, based on the choice of single or bridge, the possible second DV selections available to the user will include only the restoration types compatible with the choice of either single or bridge. Accordingly, the third DV selection can include selection of the production output, and the set of all DVs within the third DV selection can include in-house production, centralized production, etc. However, based on the choice of single or bridge, and then the choice of full, reduced, coping, or pontic crown that is compatible with single or bridge, the possible third DV selections available to the user may include only the in-house or centralized production options compatible with both the first DV selection and second DV selection. This process can then be repeated until all DV selections can be made.

The possible DV selections that have been filtered by the CCE to be compatible with the already selected DVs can be displayed in a UI in many different formats, sequences, and combinations. The UI allows a user to interact with the CCE, such as by inputting biographical or identifying information for the generation of a case, making decisions regarding various features of the 3D representation of the prosthodontic treatment, and even processing the final virtual model into a communication and order for a final manufacturer or miller.

Embodiments of a bottom portion of the workflow allows users to set restoration specific features that define the fitting and the material integrity of the final restoration. The definition of DVs of the bottom portion can be split-up into several consecutive steps, such as margin line, insertion path, fitting, and material thickness. The definition of the bottom part DVs can be precisely defined since all parameter changes are displayed in real-time and therefore can be adapted to a specific condition.

Defining a margin line allows for a definition of the edges or boundaries of the preparation done by the dentist. Defining a path of insertion allows for a definition of the direction in which a dental restoration is placed into or removed from the supporting tissues or abutment teeth and verify that the insertion line does not interfere with other teeth. Defining a fitting allows for a definition of how tight or loose the restoration fits on the prepared tooth by defining the gap (such as the cement gap) in-between the restoration and the preparation. For example, the larger the cement gap, the less volume available for the core and outer shell. Defining the material minimum thickness allows for adaptation of the material minimum thickness parameters in relation to the proximal and occlusal spatial conditions since the anatomy has already been placed in a previous workflow step. The minimum material thickness has to be defined in relation to the physical material used to produce the restoration and the production process for producing the restoration, e.g., milling, sintering, printing, casting, in order to ensure the integrity of the restoration. The adjustment of the minimum material thickness can be a decision to increase or decrease the minimum material thickness based on real-time information the CCE produces regarding the impact of the minimum thickness on the desired shape of the anatomy. The minimum material thickness can be standardized or given by suppliers or producers of the restoration.

Embodiments of the present disclosure can also break apart the traditionally unified steps of the adjustment of the shell, core, and connectors of the restoration. In the present disclosure, the shell workflow step provides a subset of design and adaptation tools to make final adjustments to the anatomical features of the restoration now that the anatomy (outside of the crown) and the bottom (crown inside) have been connected. The core workflow step is there to reduce a crown based on the modifications done in the shell workflow step. The reduced crown is a framework evenly reduced based on the anatomy. With this approach the framework supports the ceramic which will be layered on top in a manual process. The bridge connectors are typically placed during the design workflow steps, but this can lead to various problems since users can modify the anatomies and the connector shape at the same time. Breaking the shell, core, and bridge connector decisions apart improves user understanding by decreasing the complexity of the user interface decisions.

After selection of the restoration type, and the bottom portion of the workflow is sufficiently completed, the user can see where the contact points of other teeth onto the restoration are too intense. Even after the restoration type has been selected and designed, the shape of the anatomy and restoration can be modified to comply with the needs of the oral situation.

This design workflow allows for restoration specific decisions to be made as the information necessary to ascertain compatibility with prior decisions is available. Therefore, every environmental condition does not need to be taken into consideration before a restoration specific decision is made.

After the restoration type has been selected the finished product can be reviewed within the CCE. The finished model can be exported, e.g. to a milling system, for final production of the physical restoration.

Implant-Borne restorations differ from tooth-borne restorations in various ways. An implant-borne restoration is a permanent solution that includes an implant that osseointegrates with a bone of the patient's jaw. The implant is usually quasi-cylindrical with both an internal and external screw, where the internal threading has an abutment. An abutment serves the same purpose as the preparation tooth, and a crown can be formed on that abutment. The abutments of an implant can be connected to some sort of bond.

In an embodiment of the present disclosure, after the initial clinical treatment, the patient's oral situation can be defined at the beginning of case creation, instead of the final restoration outcome. For example, if an implant has been placed, a user can select implant instead of the restoration type abutment. If two implants have been placed and a tooth has been extracted, a user can define the patient's oral situation as implant, gingiva, implant instead of the restoration type bridge (crown on implant-pontic-crown on implant). In embodiments of the present disclosure, the initial stage of case creation requires only that users define what they see on the model, the oral situation, instead of completely defining the final restoration and all its properties.

As described above, an oral scan can be imported into the CCE either before or after the oral situation is described to the CCE. After importation, the 3D model may then be trimmed and oriented to the CCE's coordinate system as described above.

Depending on whether the patient has already had teeth extracted and implants mounted in their place, the workflow can provide for selecting implants to be mounted or for simply identifying the type of implants that have already been mounted. In either case, various implant related features are selected. For example, the user can select an implant library provider, brand, connection, and scanbody type. The exact position of the scanbody in the 3D model defines the exact position of the implant in the patient's oral cavity. The selection of a scanbody selects an implant library that a user can use to replace a scanbody in a digital 3D model with a digital representation of the implant and its interface based on the exact angle and location of the extracted scanbody. The selection of a preset implant library can be done with the help of a specific filter that reduces the number of libraries simultaneously shown and therefore simplifies the user experience. The implant library also includes information on the tissue level, bone level, shape of adjacent teeth, etc., and can contain a different library for each desired parameter. A specific implant library can be specified based on the oral conditions of the patient. For instance, if a bone level implant with an RC connection is desired, an RC can be selected from the implant library, and a geometry of the common RC connection can be loaded into the model. Another advantage of this new approach is that the software gives a visual representation of both the scanned scanbody and the digital scanbody. The scanbody provides information to the user regarding the orientation of the scanbody in the jaw and how the scanbody is positioned and placed in the jaw. The scanbody can be linked to the manufacturer in order to provide data informing a swap of the scanbody with a specific implant.

After some scan file preparations, the anatomy library can be selected as described above. The selected tooth shape/form can be projected approximately on the already defined implant location. This helps to check if the selected tooth shape is suitable regarding the residual teeth. Various tooth shapes can be selected and the selection can be reflected in on the 3D model's implant area inside the 3D view.

After an anatomy has been selected from the anatomy library, the selected anatomy can now be placed, scaled, deformed, copied (residual teeth) or cloned (wax up). This provides the first indication on which implant-borne restoration type can be chosen and how the final restoration can be designed depending on the surrounding areas (opposing arch, residual teeth and gingiva conditions). Unlike in prior CAD solutions, the placement of the anatomy is not restricted. This is because the emergence profile line, cement gap, and material minimum thickness have not yet been defined at this point in time. The resulting anatomy shape and its position can be preserved throughout the entire design workflow. Even after changes to the inner part (bottom) or changes to the restoration type, the anatomy will not be modified.

Similar to the tooth-borne restoration, a treatment plan for an implant-borne restoration can be generated by a series of increasingly restricted options. The DV selection is driven by a top-to-bottom filter approach, which means that users can be gradually guided through the different selections. With this approach the software is capable of only providing valid combinations of DV selections.

Every DV in the treatment plan can influence the subsequent DV in a defined order and narrows down possible selections. Embodiments of the present disclosure are driven by a top-to-bottom filter approach to creating the treatment plan. Embodiments of a top portion deploy a design workflow with a following structure: the 1st DV selection narrows down the possible selections for the 2nd DV; the 2nd DV selection narrows down the possible selections for the 3rd DV; the 3rd DV selection narrows down the possible selections for the 4th DV; the 4th DV selection narrows down the possible selections for the 5th DV, and controls if the 5th DV is available at all. Exemplary contents of each DV selection can include a 1st DV selection of single or bridge; a 2nd DV selection of restoration type, e.g., abutment, full crown on implant, reduced crown on implant; a 3rd DV selection of production output, e.g., in-house or centralized production; a 4th DV selection of the type of material used to form the anatomy, e.g., ceramic, zirconium; and a 5th DV of the material color. At each stage of the workflow, the possible selections for the DV can be limited by the anatomy of the restoration, i.e. possible DVs can be filtered based on compatibility/incompatibility with the 3D geometry that defines an exterior surface of the one or more crown portions of the dental restoration.

The bottom part step is the place where restoration specific features can be set that define the fitting and the material integrity of the final restoration. The bottom part step also includes an increasingly restrictive set of DV selections. An exemplary order of DV selections, with each selection influencing every successive DV selection, would first select the prosthetic elements, then the rotation (if an angulated screw channel is selected), the fitting parameters the minimum material thickness and the emergence profile of the restoration. The tagging and positioning of the implant can influence the possible DV selections within set of DV selections. For instance, the location of the implant can influence the choice of prosthetic elements, e.g. abutments, and the location of the implant and prosthetic elements can influence whether or not an angulated screw channel is necessary, i.e., whether rotation needs to be selected, and since the anatomy has already been placed in a previous design workflow step, users are able to adapt the fitting, cutter radius compensation, and minimum material wall thickness parameters in relation to the proximal and occlusal spatial conditions. The information on these DV selections can then all be used to inform the shape of the emergence profile of the restoration, where the restoration meets the gingiva.

After the DV selections of the bottom portion are made, the shell, core, and bridge connectors can be individually and successively chosen. The shell workflow step provides a subset of design and adaptation tools to make final adjustments to the anatomical features of the restoration now that the anatomy and the bottom (crown inside) have been connected. The core workflow step is exclusively available for reduced tooth-borne restoration and all implant-borne restorations. While bridge connectors are typically placed during the design workflow steps, this can lead to various problems since users can modify the anatomies and the connector shape at the same time.

After the restoration type has been selected, the finished product can be reviewed within the CCE. The finished model can then be exported, e.g. to a milling system, for manufacture of the physical restoration.

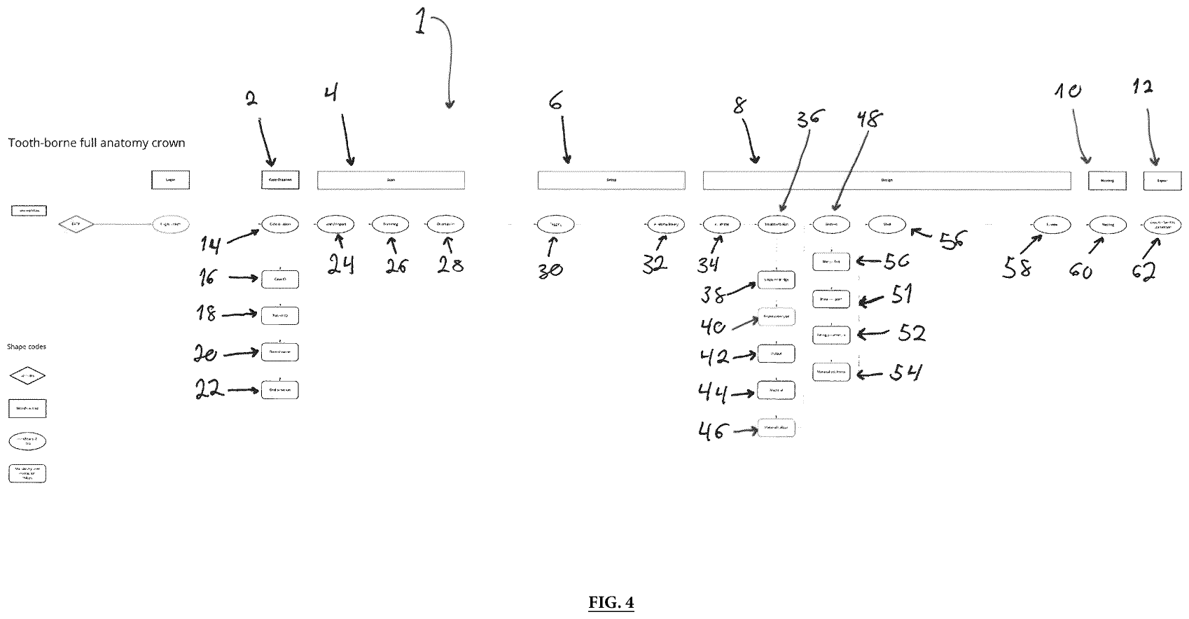

In the embodiment of FIG. 4, creation of a prosthodontic model for a tooth-borne full anatomy crown in a CCE 1 can be achieved through a number of processes, where each of those processes contains a number of steps to be performed either by the software or the user. The exemplary processes of FIG. 4 are case creation 2, scan 4, setup 6, design 8, nesting 10, and export 12. Nesting involves virtually placing the final restoration geometry inside a virtual representation of a milling blank (typically a disc or block) to determine the physical size of the blank needed to properly position the restoration so as to be able to mill the restoration in the most efficient manner possible. The steps to be performed within each process can vary, e.g., based on the needs of the patient or the nature of the prosthodontic model, and the order of the process or steps contained within each process can differ from embodiment to embodiment, e.g., where a scan 24 may be imported, which in the embodiment of FIG. 4 is a step of the scan 4 process, before identifying an oral situation 22, which is a step of the case creation 2 process, or alternatively an oral situation 22 may be identified before importing a scan 24 as shown in FIG. 4.

In the embodiment of FIG. 4, at the case creation 2 process various identifying and case referencing information to create a case 14, such as the case ID 16 identifier, the patient ID 18 identifier, and the dentists or users name 20. As a step of the case creation 2 process, the oral situation 22 may be defined before importing a scan 24 during the scan 4 process. Defining an oral situation 22 can include providing information to the CCE 1 such as the status of specific teeth, what portion of the teeth remain, where those teeth are located, etc. For example, a specific tooth can be identified as a preparation if it is only partially missing and part of the tooth still remains, or it can be labeled ‘missing tooth’ if none of the tooth remains. Teeth not needing repair can be ignored or described in the case creation. In another embodiment, a scan 24 may be imported before defining the oral situation 22. Either exemplary embodiment shows that processes, such as the case creation 2 process and scan 4 process, can overlap or include different steps than those depicted in FIG. 4 as being associated with each process. In other words, processes are not strictly limited to specific collections of steps.

During the scan 4 process of FIG. 4, a scan 24 may be imported to the CCE 1. Importing the scan can include importing scans of multiple portions of the jaw, such as the upper, lower, bite, upper wax-up, lower wax-up, upper gingiva and lower gingiva can be integrated and rendered into a 3D model. The 3D model can undergo trimming 26 so that only the relevant portions of the model are focused on. The 3D model can then undergo an orientation 28 step, which can include coordinate transformation of the files of the 3D model to the coordinate system of the CCE 1 or a reorientation of the 3D model to the appropriate orientation for the coordinates of the CCE 1. The 3D model can be depicted as a model of the scan able to manipulated and oriented as desired within the CCE 1. The step of orientation 28 can assist the model's responsiveness to manipulation by dividing the model along at least one axis, such as by inserting a coordinate plane in the angle and plane of the bite of the model. Adapting the 3D model to the coordinate system of the CCE 1 also aids subsequent steps within the CCE 1, as the upper model of the jaw and the lower model of the jaw can be examined and considered separately at various steps, and allows for manipulation and adjustment of a single upper or lower jaw.

During the setup 6 process of FIG. 4, the 3D model can be tagged 30. Tagging serves many functions, such as identifying the portions of the model that correspond to important features of the oral situation, e.g., identifying tooth numbers, positioning, status of the tooth (present, missing, partial, stump). After the 3D model is tagged 30, the anatomy library can be generated and/or selected from 32. The anatomy library is a library of preset prosthetic tooth anatomies, where the anatomies of the anatomy library vary in shape and form. Selection of an anatomy 34 from the anatomy library 32 can be aided by filtering the anatomies to find a set of anatomies that represent the respective oral situation. For instance, anatomy libraries may contain different anatomies based on factors of the current case such as age, gender, dietary or medical conditions of the patient, or the position of the teeth needing attention. The anatomy library can project anatomies onto the identified teeth while viewing the various anatomies to assist in selecting an appropriate anatomy. Selection from the anatomy library 32 could be both a user driven filtering system or an artificial intelligence aided filtering system. However, the selection of the anatomy 34 need not come from an anatomy library of the embodiment of FIG. 4; a desired anatomy can be imported to the CCE 1.

In the design 8 process of FIG. 4, the user can design various features of the potential prosthetic tooth using a top-to-bottom approach. After an anatomy is selected 34 for use from the anatomy library 32, the anatomy can be shaped, sculpted, duplicated, fit, waxed up, edited, etc., within the CCE 1 to conform to the oral situation 22 as needed. Following the selection and design of an anatomy 34, a treatment plan can be constructed 36. The creation of a treatment plan 36 is referred to as the top portion of a series of selections of DVs of the anatomy, i.e., DV selections, to be made to gradually define the end result, or final prosthetic. In the embodiment of FIG. 4, the CCE 1 presents each DV selection to be made from a set of DV selections 38, 40, 42, 44, 46 in light of the DV selections that have already been made.

For the embodiment of FIG. 4, the CCE 1 processes the choice between a single prosthodontic or a bridge linking multiple prosthodontics, both DVs of the anatomy, from the first set of DV selections 38. Then, when the choice of which restoration type, e.g., full crown, full pontic, etc., is to be made from the second set of DV selections 40, the CCE 1 presents or allows selection of only the restoration types that are compatible with the choice of single or bridge, given the oral situation 22. Similarly, when a choice is to be made regarding the output, e.g., stereolithography (STL), manufacturer specific output, etc., from the third set of DV selections 42, the CCE 1 presents or allows selection of only those outputs for the anatomy that are compatible with both the chosen restoration type from the second set of DV selections 40 and the choice of single or bridge from the first set of DV selections 38. Therefore at this stage, the choice of restoration type is compatible with the choice of single or bridge, and the choice of output is compatible with both the restoration type and the choice of single or bridge. When a choice of materials of the anatomy, e.g., ceramic, zirconium, etc., is to be made from the fourth set of DV selections 44, the CCE 1 presents only those choices for materials that are compatible with the choices made regarding single or bridge, restoration type, and output. Accordingly, when a choice is to be made regarding the material color of the anatomy from the fifth set of DV selections 46, the CCE 1 presents or allows selection of only those choices for colors of the material that are compatible with choices made regarding single or bridge, restoration type, outputs, and material. Therefore, the choice from the fifth set of DV selections 46 is compatible with the DV selections made from each set of DV selections 38, 40, 42, 44.

By the CEE's 1 restriction of choices at each step of the embodiment of FIG. 4, the CCE 1 can ensure that the choice of DV from each successive set of DV selections is compatible with the previous choices of feature selections.

The bottom DVs selection 48 of the design process 8 of FIG. 4 includes the bottom portion of the top-to-bottom gradual design portion. In the embodiment of FIG. 4, the CCE 1 presents each DV selection from a set of DV selections 50, 51, 52, 54, in light of all DV selections previously made. Based upon the chosen margin line of the first set of bottom DV selections 50, the CCE 1 will limit the number of available choices of insertion paths in the second set of bottom DV selections 51, the fitting parameters in the third set of bottom DV selections 52, and the material thickness in the fourth set of bottom DV selections 54. In other words, based on the chosen margin line, the CCE 1 will limit what insertion path and fitting parameters will be chosen and material thickness can be chosen to only those choices that are compatible with the previous DV selections, anatomy, and oral situation 22.

During selection of the bottom DV selections, the selection of the margin line can also be suggested by the CCE 1, manually entered, or detected in a number of ways. The selection of insertion path can be assisted by a number of suggestions or manual entries that comply with the chosen anatomy DVs and oral situation. The selection of fitting parameters includes a number of different parameters of the anatomy bottom, such as the marginal gap size, the chamfer gap size, the cement gap size, the collar offset size, etc. The specification of the material thickness can be provided in a number of ways, and the CCE 1 can intake the specifications and give an immediate indication of whether the given specifications comply with the currently selected DVs and oral situation.

The selection of a shell 56 during the design 8 process of FIG. 4 follows the creation of a treatment plan 36 and bottom 48. The selection of a shell involves shaping and sculpting the shell, as well as specifying the occlusal or proximal conditions the shell will occupy.

In the embodiment of FIG. 4, after a shell has been selected 56, the resultant product of the case creation 2, scan 4, setup 6, and design 8 processes can be reviewed 58. The resultant prosthetic model can then be nested 60 during the nesting 10 process.

After the nesting 10 process, the export 12 process can include sending or exporting 62 the resultant prosthetic model to an entity capable of milling, forming, or creating the prosthetic model.

The exemplary DV selections of each set of successive DV selections of the embodiments are not necessarily confined to a rigid order. It is possible for sets of DV selections to be made in various orders or for multiple sets of DV selections to be available at one time. In this case, whatever set of DV selections is chosen from first will become the first set of DV selections and the second choice will be influenced by the first choice, so on and so forth.

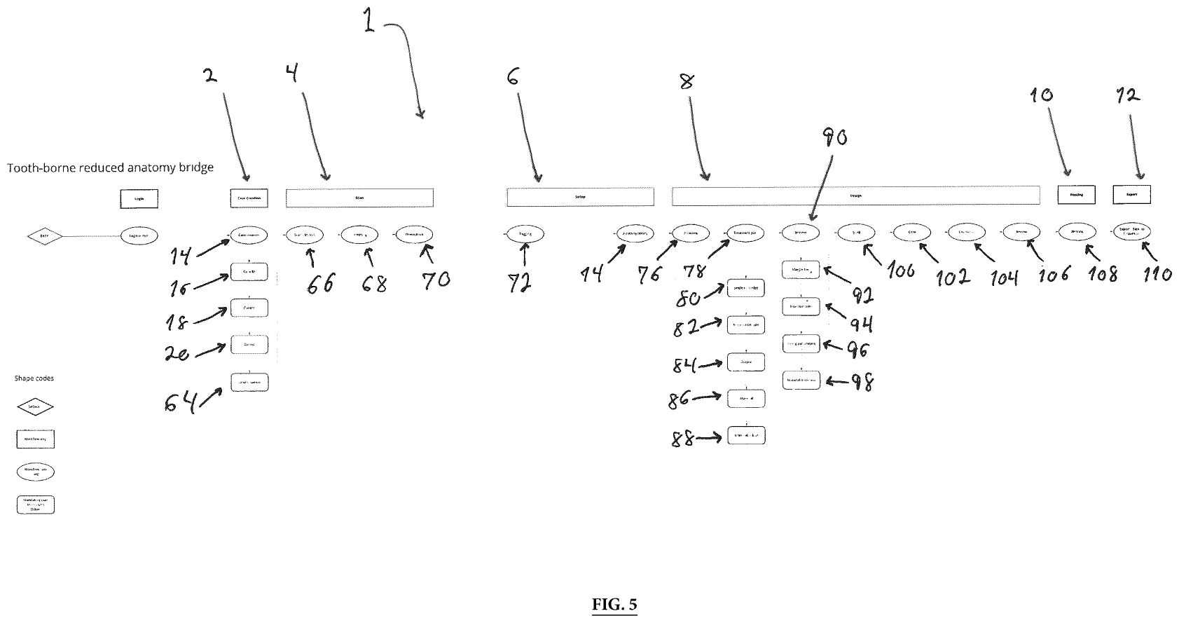

In the embodiment of FIG. 5, creation of a prosthodontic model for a tooth-borne reduced anatomy bridge in a CCE 1 can be achieved through a number of processes similar to the processes of the embodiment of FIG. 4, where each of those processes contains a number of steps to be performed either by the software or the user. The embodiment of FIG. 5 includes the processes of case creation 2, scan 4, setup 6, design 8, nesting 10, and export 12. As in the embodiment of FIG. 4, the processes of the embodiment of FIG. 5 are not necessarily in a limited order or tied to any specific collection of steps.

During the case creation 2 process of FIG. 5, the user can input case ID 16, patient information 18, and dentist information 20. The oral situation 64 can then be created in the CCE 1 either before or after importing a scan 66. Trimming 68 can then be performed on the 3D model and the model can be oriented 70 within the CCE. During the setup 6 process, the 3D model can be tagged 72 and a provided anatomy library 74 can be accessed to present anatomies to select from.

The design 8 process of the embodiment of FIG. 5 begins with the selection of an anatomy 76. Once an anatomy has been selected 76, a treatment plan can be created 78 through DV selections made using a successive series of sets of DV selections 80, 82, 84, 86, 88 that take information from the previous DV selections to show only those options of the current set of DV selections that are compatible with the previous DV selections. In the embodiment of FIG. 5, the first set of DV selections 80 involves selection of a single or bridge, the second set of DV selections 82 involves the restoration type, the third set of DV selections 84 involves the outputs, the fourth set of DV selections 86 involves the materials to form the anatomy from, and the fifth set of DV selections 88 involves the color of the material of the anatomy.

After the creation of the treatment plan 78, i.e., completion of the top portion of the top-to-bottom gradual approach to potential prosthetic tooth creation, creation of the bottom 90 portion includes DV selections from the successive sets of DV selections 92, 94, 96, 98. Similar to the DV selections 80, 82, 84, 86, 88, the successive bottom sets of DV selections 92, 94, 96, 98 take information from the previous bottom DV selection and show the options of the current set of bottom DV selections that are compatible with the previous DV selection. In the embodiment of FIG. 5, the first set of bottom DV selections 92 involves the margin line, the second set of bottom DV selections 94 involves the insertion path, the third set of bottom DV selections involves the fitting parameters, and the fourth set of bottom DV selections 98 involves a material minimum thickness of the final restoration, e.g. a material minimum thickness of a crown portion of the restoration. The selection of insertion path can be assisted by a number of suggestions or manual entries that comply with the chosen anatomy DVs and oral situation 64.

After the creation of the treatment plan 78 and bottom portion 90, the creation of a shell 100 of the anatomy can be performed. Following the selection of the shell 100, selection of a core 102 can be made. The selection of the core 102 can involve shaping and sculpting the core, along with reducing or increasing the various dimensions of the core within the CCE 1 and receiving real time indications of the adjustment's compatibility. Selection of a connector 104 follows the selection of the core 102, and within the CCE 1 can include supplying or editing the distal, medial, and mesial dimensions of the connectors, correlated to indications of the connector's positioning within the teeth that the connector will connect. In the embodiment of FIG. 5, after the selection of connector 104, the final model can be reviewed 106, and various portions of the design process returned to. The resultant prosthetic model can then be nested 108 during the nesting 10 process. After the nesting 10 process, the export 12 process can include sending or exporting 110 the resultant prosthetic model to an entity capable of milling, forming, or creating the prosthetic model. The exportation 12 process and exportation 62 can provide various bits of information to the mill in varying level of details and associated with the case information.

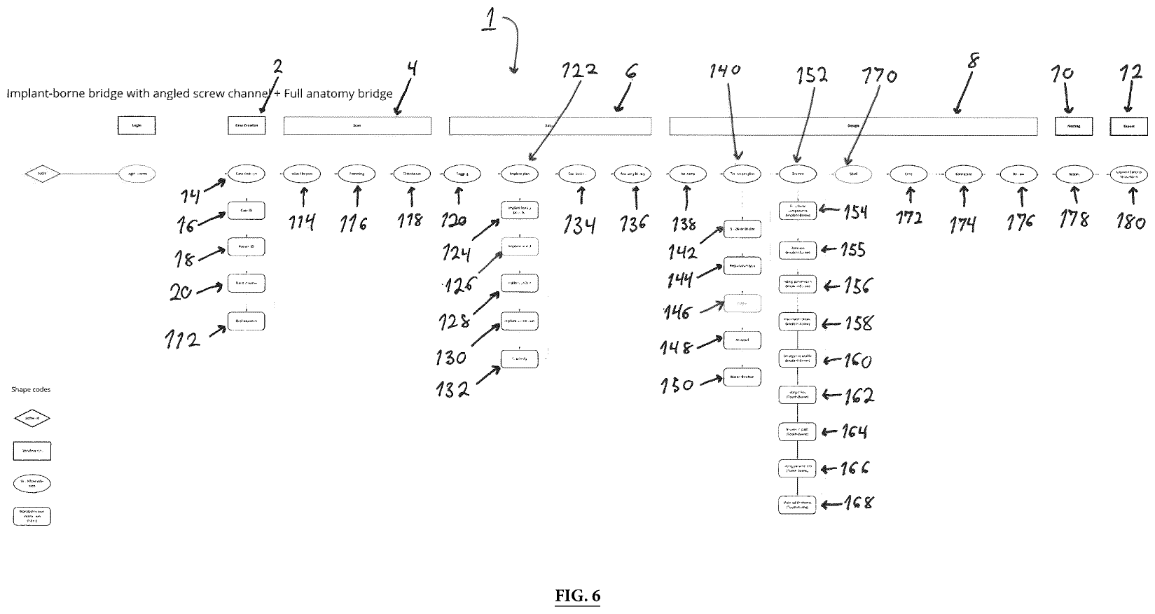

In the embodiment of FIG. 6, creation of a prosthodontic model for an implant-borne bridge with angled screw channel and full anatomy bridge in a CCE 1 can be achieved through a number of processes, where each of those processes contains a number of steps to be performed either by the software or the user. The exemplary processes of FIG. 6 are case creation 2, scan 4, setup 6, design 8, nesting 10, and export 12.

During the case creation 2 process of FIG. 6, the user can input case ID 16, patient information 18, and dentist information 20. The oral situation 112 can then be created in the CCE 1 either before or after importing a scan 114, with or without reference to the model of the scan generated by the CCE 1. In addition to the information able to be input in the embodiment of FIG. 4, creation of the oral situation 112 includes the ability to indicate the specific teeth that have or will have implants.

During the scan 4 process of the embodiment of FIG. 6, the intraoral scan can be imported 114, trimmed 116, and oriented 118 to the coordinate system of the CCE 1.

The setup 6 process of the embodiment of FIG. 6 begins with tagging the model 120 to identify the relevant tooth, implant, gingiva positioning, and creation of an implant plan 122. The tagged implant (scanbody) position can be associated with the virtual implant generated from the implant plan. In the embodiment of FIG. 6, the creation of the implant plan 122 includes identifying an implant that has previously been installed in a patient's jaw. Once the implant has been identified/selected, a scanbody in a digital 3D model can be selected by the user and replaced by the identified/selected implant. In the embodiment of FIG. 6, the successive sets of DV selections 124, 126, 128, 130, 132 account for information provided in each DV selection prior to the current DV selection being made. The embodiment of FIG. 6 provides a first set of implant DV selections 124 from an implant library, such as one given by an implant library provider, a second set of implant DV selections 126 involving an implant provider brand, a third set of implant DV selections 128 involving implant systems, such as a tissue level system, a fourth set of implant DV selections 130 involving forms of implant connections, such as an RN regular neck, and a fifth set of implant DV selections 132 involving the scanbody of an implant. The implant library provider may provide an implant library that includes both digital models for implants as well as various abutment constructions capable of being connected to various implants. Implant library providers may provide implant libraries that include implants produced by multiple manufacturers.

In the embodiment of FIG. 6, as the DV selections from each set of DV selections is made, the implant plan can be populated into the model generated by the CCE 1 of the imported scan. A digital scanbody can be selected or produced 134 and associated with the implant generated from the chosen implant plan 122. Associating the scanbody 134 with the scanned implant also provides for a validation of the scanbody selection before continuing to select an anatomy. Providing, generating, and/or searching an anatomy library 136 can then follow the digital association of a scanbody 134 to the implant plan.

The design 8 process of the embodiment of FIG. 6 begins with the selection of an anatomy 138. An anatomy, once rendered into the modeling environment of the CCE 1, can be manipulated, oriented, and placed over portions of the 3D model generated from the imported oral scan from the scan 4 process. The anatomy can be reshaped and resized within the modeling environment, and the CCE 1 can provide real time feedback to the user as changes are made to indicate the validity or compatibility of those changes with the oral situation 112 or various DV selections already made. Moreover, the way in which the anatomy will connect to the implant or emerge from the soft tissue (gingiva) can be displayed and updated as changes, e.g., shaping, sculpting, fitting, are made. After the anatomy is loaded in to the CCE 1, creation of a treatment plan 140 can begin, formed from DV selections of five successive sets of DV selections 142, 144, 146, 148, 150, with the choice of DV selection made at each set of DV selections affecting the available choices of DV selections at the following DV selections. In the embodiment of FIG. 6, the first set of anatomy DV selections 142 involves selection of a single or bridge, the second set of anatomy DV selections 144 involves the restoration type, e.g., a custom abutment, the third set of anatomy DV selections 146 involves the outputs, the fourth set of anatomy DV selections 148 involves the materials to form the anatomy from, e.g., cobalt-chromium alloys, and the fifth set of anatomy DV selections 150 involves the color of the material of the anatomy.

In the embodiment of FIG. 6, following the creation of a treatment plan 140, the creation or modeling of a bottom portion 152 can be formed by selecting features from nine successive sets of bottom DV selections 154, 155, 156, 158, 160, 162, 164, 166, 168. As with the creation of the implant plan 122 and the creation of the treatment plan 140, the bottom DV choices available in each successive set of bottom DV selections are limited by the DV choices made in each previous set of bottom DV selections. In the embodiment of FIG. 6, the first five DV selections address an implant-borne design cycle for the bottom portion 152, and last four DV selections address a tooth-borne design cycle for the bottom portion 152. The first set of bottom DV selections 154 involves selection of the prosthetic components, e.g., component group, component (TiBase/Abutment), among other information such as provider, connection, material; the second set of bottom DV selections 155 involves adjusting the rotation of the prosthetic components of the first DV selection 154; the third set of bottom DV selections 156 involves the fitting parameters, such as the cement gap; the fourth set of bottom DV selections 158 involves certain minimum material thicknesses; the fifth set of bottom DV selections 160 involves the emergence profile, e.g., shape and height of the restoration part that is typically located below the soft tissue (gingiva); the sixth set of bottom DV selections 162 involves the positioning and size of the margin line; the seventh set of bottom DV selections 164 involves selections of the insertion path; the eighth set of bottom DV selections 166 involves additional fitting parameters of the tooth-borne portion of the bottom portion 152; and the ninth set of bottom DV selections 168 involves additional material thickness of the tooth-borne portion of the bottom portion 152.

After the creation of the anatomy bottom portion 152, the creation of a shell 100 of the anatomy can be performed. The creation and alteration of the core 172 and connector 174 can follow. Adjustment of the core 172 can include various DV selections, such as providing for a screw channel and the size of the protection thickness. The design 8 process of FIG. 6 concludes with a review 176, and then proceeds to the processes of nesting 10 and exporting 12 through the steps of nesting 178 and exporting 180.

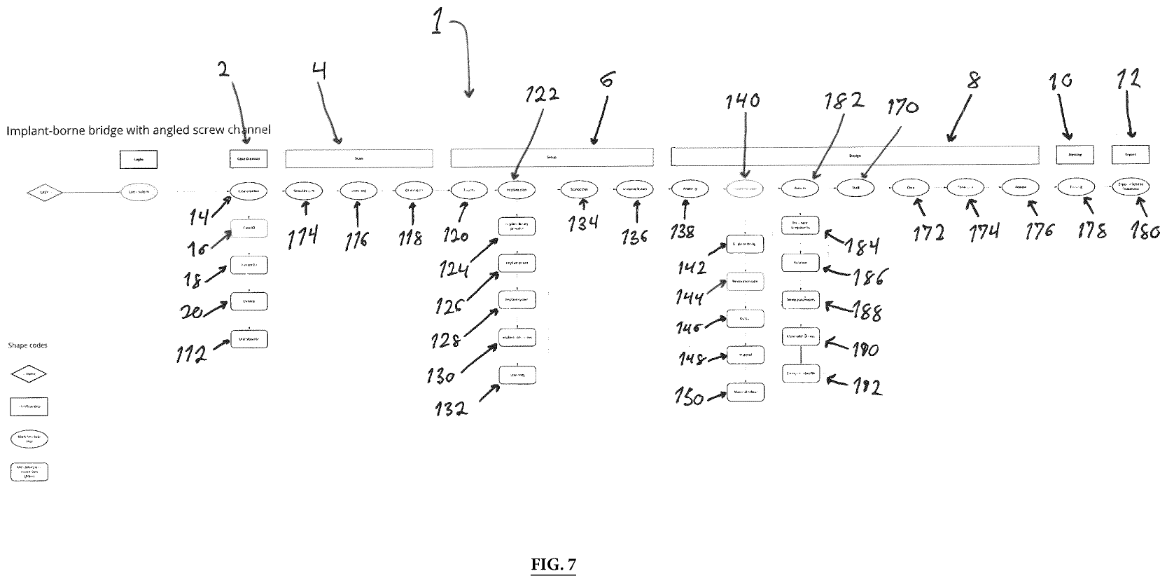

The embodiment of FIG. 7 provides for creation of a prosthodontic model for an implant-borne bridge with angled screw channel in a CCE 1. The CCE 1 of FIG. 7 deploys processes similar to the processes of FIG. 6. However, the design 8 process of FIG. 7 differs from the design 8 process of FIG. 6. In the embodiment of FIG. 7, the creation of the anatomy bottom 182 is achieved through DV selections from five successive sets of bottom DV selections 184, 186, 188, 190, 192. While the successive sets of bottom DV selections 184, 186, 188, 190, 192 relate to each other in the same way as the successive sets of bottom DV selections 154, 155, 156, 158, 160, 162, 164, 166, 168, the first set of bottom DV selections 184 involves the selection of prosthetic components, the second set of bottom DV selections 186 involves adjusting the rotation of the bottom of the anatomy, e.g., adjustment of the screw hole radius, symmetrical angle, minimum angle, and maximum angle, the third set of bottom DV selections 188 involves selecting the fitting parameters, the fourth set of bottom DV selections 190 involves adjusting the thickness of the material forming the bottom, and the fifth set of bottom DV selections 192 involves adjusting the emergence profile of the bottom of the anatomy, e.g., protection distance, distance to gingiva, etc.

In the embodiments of the present disclosure, the possible DV selections that have been filtered by the CCE 1 to be compatible with the already selected DVs can be presented and available to select from in many different formats, sequences, and combinations. For example, some sets of DV selections may not be offered at all, depending on the DV selection from prior sets of DV selections. For instance, if single is chosen, rather than bridge, the set of DV selections for the connector can be restricted, e.g., may be removed from the UI, or shown but inaccessible, or accessible but unwilling to accept entries. For another example, depending on the material thickness chosen for the anatomy, the set of DV selections for the size of the cement gap will restrict the range of valid values to comply with the oral situation, anatomy, and prior chosen DVs.

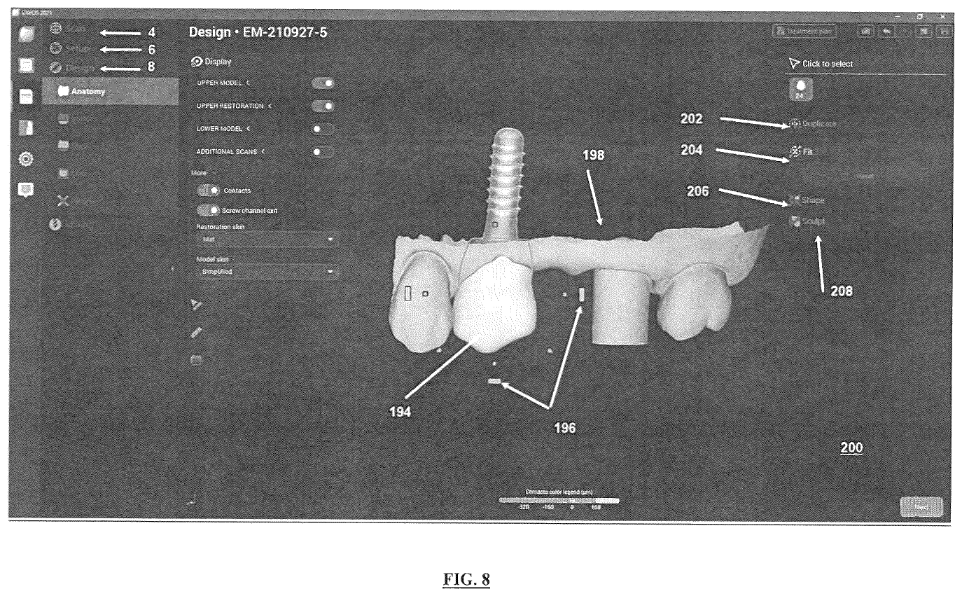

It also possible for UI to display multiple DVs, DV selections, and sets of DV selections at one time. For example, the UI of the CCE 200 in the embodiment of FIG. 8 shows the anatomy 192 as a separate manipulable data structure, indicated by orientation guides 194, from the modeled oral situation 196. The 3D representation of the anatomy 192 is generated to represent the physical component of the prosthodontic treatment. As shown in FIG. 8, the 3D representation of the anatomy 192 can be rendered as a separate data structure from a 3D representation of the oral situation 196, but still be located within the same CCE 200. The 3D representation of the anatomy 192 can then be manipulated, scaled, sculpted, etc. to understand how the two representations of the anatomy 192 and the oral situation 196 will interact with each other, providing real time feedback on how a change to the 3D representation of the anatomy 196 will interact with the oral situation 196, as well as how changes to one feature of the anatomy 196 will affect subsequent or previous choices of the prosthodontic treatment DVs. FIG. 8 also shows multiple sets of DV selections displayed to the user at once, namely, the DV selections sets duplicate 202, fit 204, shape 206, and sculpt 208. The processes scan 4, setup 6, design 8 can also be seen as an indication of where the user is in the process.

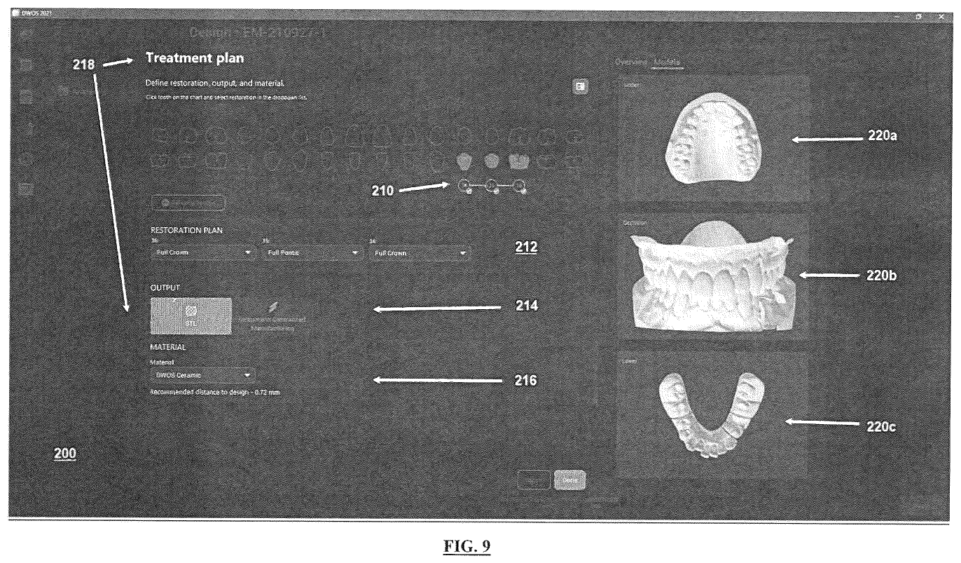

The embodiment of FIG. 9 shows that the Ul of the CCE 200 can display multiple sets of DV selections single or bridge 210, restoration plan 212, output 214, and material 216 of the set of DV selections Treatment plan 218 in tandem with different orientations of the upper oral situation 220a, occlusion oral situation 220b, and lower oral situation 220c. Moreover, the UI may present a DV selection as a request for a numerical value, such as the size of a marginal gap, and the restriction of possible DV selections from the set of DV selections is realized by restricting the range of values the CCE 200 will accept.

The various embodiments of the present disclosure allow for the steps and processes within the CCE 1 to be adjusted with a high degree of flexibility in response to available information and the needs of the case, such as the oral situation and unique features of the intraoral scans.

FIG. 10 is a block diagram of an exemplary processing system, which can be configured to perform operations disclosed herein. Referring to FIG. 10, a processing system 320 can include one or more processors 322, memory 324, one or more input/output (I/O) devices 326, one or more sensors 328, one or more UIs 330, and one or more actuators 332. Processing system 320 can be representative of each computing system disclosed herein.

Processors 322 can include one or more distinct processors, each having one or more cores. Each of the distinct processors can have the same or different structure. Processors 322 can include one or more central processing units (CPUs), one or more graphics processing units (GPUs), circuitry (e.g., application specific integrated circuits (ASICs)), digital signal processors (DSPs), and the like. Processors 322 can be mounted to a common substrate or to multiple different substrates.

Processors 322 are configured to perform a certain function, method, or operation (e.g., are configured to provide for performance of a function, method, or operation) at least when one of the one or more of the distinct processors is capable of performing operations embodying the function, method, or operation. Processors 322 can perform operations embodying the function, method, or operation by, for example, executing code (e.g., interpreting scripts) stored on memory 324 and/or trafficking data through one or more ASICs. Processors 322, and thus processing system 320, can be configured to perform, automatically, any and all functions, methods, and operations disclosed herein. Therefore, processing system 320 can be configured to implement any of (e.g., all of) the protocols, devices, mechanisms, systems, and methods described herein.

For example, when the present disclosure states that a method or device performs process, step, or task “X” (or that task “X” is performed), such a statement should be understood to disclose that processing system 320 can be configured to perform task “X”. Processing system 320 is configured to perform a function, method, or operation at least when processors 322 are configured to do the same.

Memory 324 can include volatile memory, non-volatile memory, and any other medium capable of storing data. Each of the volatile memory, non-volatile memory, and any other type of memory can include multiple different memory devices, located at multiple distinct locations and each having a different structure. Memory 324 can include remotely hosted (e.g., cloud) storage.

Examples of memory 324 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 324.

Input-output devices 326 can include any component for trafficking data such as ports, antennas (i.e., transceivers), printed conductive paths, and the like. Input-output devices 326 can enable wired communication via USB®, DisplayPort®, HDMI®, Ethernet, and the like. Input-output devices 326 can enable electronic, optical, magnetic, and holographic, communication with suitable memory 326. Input-output devices 326 can enable wireless communication via WiFi®, Bluetooth®, cellular (e.g., LTE®, CDMA®, GSM®, WiMax®, NFC®), GPS, and the like. Input-output devices 1206 can include wired and/or wireless communication pathways.

UI 330 can include displays, physical buttons, speakers, microphones, keyboards, and the like. Actuators 332 can enable processors 322 to control mechanical forces.

Processing system 320 can be distributed. For example, some components of processing system 320 can reside in a remote hosted network service (e.g., a cloud computing environment) while other components of processing system 320 can reside in a local computing system. Processing system 320 can have a modular design where certain modules include a plurality of the features/functions shown in FIG. 10. For example, I/O modules can include volatile memory and one or more processors. As another example, individual processor modules can include read-only-memory and/or local caches.

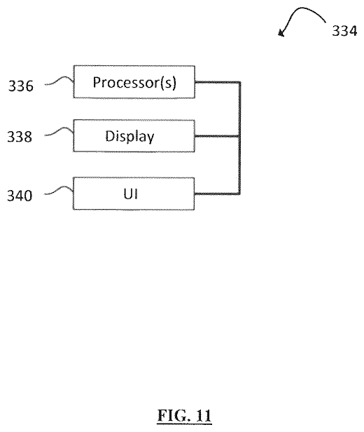

FIG. 11 is a block diagram of a system configured to perform operations described herein. At least one or more processor(s) 336 are configured to perform the design process, such as the processes of case creation 2, scan 4, setup 6, design 8, nesting 10, and export 12. Moreover, the processors 336 are configured to receive information, such as user input, scan information, cloud connectivity information, etc., and concurrently operate the design processes of the present disclosure. Processors 336 can perform operations embodying the function, method, or operation by, for example, executing code (e.g., interpreting scripts). Display 338 is configured to display the outputs of the processors and present outputs of the processors to the user that inform the user and aid the user to interact with the design processes of the present disclosure. The UI 340 of is configured to present information to the user in a format that that the user can interact with, and receive user input. Upon receiving an input through the UI 340, the processors 336 are configured to process the user input.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for creating a digital dental restoration, the method comprising:
receiving a three-dimensional virtual model of oral structures of a patient;
receiving classification data classifying an oral situation of the patient;
determining a three-dimensional (3D) geometry that defines a surface anatomy of the digital dental restoration;
automatically filtering, based on the determined 3D geometry, a set of possible first restoration design variables by restricting respective first restoration design variables to be compatible with the determined 3D geometry; and
receiving an input that identifies a selected first restoration design variable from the filtered set of first restoration design variables.

2. The method of claim 1, wherein the 3D geometry that defines the surface anatomy of the digital dental restoration is a 3D geometry that defines an exterior surface of one or more crown portions of the restoration.

3. The method of claim 2, wherein determining the 3D geometry that defines the surface anatomy of the digital dental restoration comprises creating a data structure that defines the exterior surface of the one or more crown portions of the restoration.

4. The method of claim 3, wherein the data structure is a polygon mesh.

5. The method of claim 4, wherein the polygon mesh is a triangle mesh.

6. The method of claim 1, wherein the classification data provides a respective condition of each of one or more teeth of the patient that are to be replaced by the dental restoration.

7. The method of claim 6, wherein the respective condition is selected from a set of tooth conditions, the set of tooth conditions including one or more of: the respective tooth is a preparation tooth, an implant replaces the respective tooth, the respective tooth has been extracted and is not replaced by an implant.

8. The method of claim 6, the method further comprising:
after determining the 3D geometry that defines the surface anatomy of the digital dental restoration, determining, for each respective tooth of the one or more teeth of the patient that are to be replaced by the dental restoration, a respective restoration type.

9. The method of claim 8, wherein the determining, for each respective tooth of the one or more teeth of the patient that are to be replaced by the dental restoration, the respective restoration type comprises receiving, for each respective tooth of the one or more teeth of the patient that are to be replaced by the dental restoration, user input indicating the respective restoration type.

10. The method of claim 8, wherein the respective restoration type is selected from a set of restoration types, the set of restoration types including one or more of: an implant-supported crown, a preparation tooth-supported crown, a pontic, an implant-supported partial crown, a preparation tooth-supported partial crown, an inlay, an onlay, an overlay, a veneer.

11. The method according to claim 8, wherein the set of possible first restoration design variables includes, for each respective tooth of the one or more teeth of the patient that are to be replaced by the dental restoration, one or more of: a margin line, an emergence profile, a cement gap, a crown material minimum thickness.

12. The method according to claim 11, wherein restricting respective first restoration design variables that are incompatible with the determined 3D geometry comprises specifying one or more of: valid margin line parameter ranges, valid emergence profile parameter ranges, valid cement gap parameter ranges, valid crown material thickness ranges.

13. The method according to claim 12, wherein receiving an input that identifies a selected first restoration design variable from the filtered set of first restoration design variables includes receiving one or more of: valid margin line parameters, valid emergence profile parameters, valid cement gap parameters, valid crown material thicknesses.

14. The method according to claim 8, wherein the set of possible first restoration design variables includes one or more of: an implant-mounted abutment, an implant-mounted bar, a bar-mounted restoration.

15. The method according to claim 14, wherein restricting respective first restoration design variables that are incompatible with the determined 3D geometry comprises specifying one or more of: valid parameters for an implant-mounted abutment, valid parameters for an implant-mounted bar, valid parameters for a bar-mounted restoration.

16. The method according to claim 1, further comprising automatically filtering, based on the determined 3D geometry and the selected first restoration design variable, a set of possible second restoration design variables by restricting second restoration design variables to be compatible with a combination of the determined 3D geometry and the selected first restoration design variable.

17. The method according to claim 16, wherein the set of possible second restoration design variables includes a set of possible materials and material colors for use in manufacture of a dental restoration corresponding to the digital dental restoration.

18. The method according to claim 17, wherein the restricting second restoration design variables to be compatible with a combination of the determined 3D geometry and the selected first restoration design variable includes eliminating, from a set of materials and corresponding material colors provided for the manufacture of dental restorations, those materials and corresponding material colors that are not compatible with the determined 3D geometry and the selected first restoration design variable.

19. A system for creating a digital dental restoration, the system comprising:
processing circuitry;
a display configured to provide a user interface and to display a visual rendering of the digital dental restoration; and
a user input device configured to receive user input for communication to the processing circuitry;
wherein the processing circuitry is configured to:
receive a three-dimensional (3D) virtual model of oral structures of a patient,
receive classification data classifying an oral situation of the patient,
determine a 3D geometry that defines a surface anatomy of the digital dental restoration,
automatically filter, based on the determined 3D geometry, a set of possible first restoration design variables by restricting respective first restoration design variables to be compatible with the determined 3D geometry, and
receive an input, provided via the user input device, that identifies a selected first restoration feature from the set of first restoration features.

20. A non-transitory computer-readable medium having instructions stored thereon that, upon being executed by processing circuitry, cause the processing circuitry to carry out a method for creating a digital dental restoration, the method comprising:
receiving a three-dimensional (3D) virtual model of oral structures of a patient;
receiving classification data classifying an oral situation of the patient;
determining a 3D geometry that defines a surface anatomy of the digital dental restoration;
automatically filtering, based on the determined 3D geometry, a set of possible first restoration design variables by restricting respective first restoration design variables to be compatible with the determined 3D geometry; and
receiving an input that identifies a selected first restoration design variable from the filtered set of first restoration design variables.

21. A method for manufacturing a dental restoration, the method comprising:
the method according to claim 1; and
manufacturing the dental restoration based on the digital dental restoration.
